(19) United States
(12) Patent Application Publication
(10) Pub. No.: US 2003/0182469 A1
(43) Pub. Date: Sep. 25, 2003

(54) Distributed computer system using a graphical user interface toolkit

(76) Inventors: Simon Lok, Howard Beach, NY (US); Steven Keith Feiner, New York, NY (US)

Correspondence Address: BAKER & BOTTS, 30 ROCKEFELLER PLAZA, NEW YORK, NY, 10112

(21) Appl. No.: 09/878,859

(22) Filed: Jun. 11, 2001

Related U.S. Application Data
(60) Provisional application No. 60/210,643, filed on Jun. 9, 2000.
(60) Provisional application No. 60/277,498, filed on Mar. 21, 2001.

(51) Int. Cl. G06F 9/00

(52) U.S. Cl. 709/328

(57) ABSTRACT

A distributed computer system having a server and remote client for executing an application on the server. A remote-capable user interface toolkit resides on the server and has remote-capable components that correspond to components of a user interface toolkit which resides on the remote client. The remote-capable components are substantially the same as corresponding components of the user interface toolkit, and interact with the application according to the same application programming interface. However, when invoked by the application, the remote-capable components issue a message to the component on the remote client to perform the corresponding function on the client. A network communication protocol of sending messages between the remote-capable user interface toolkit on the server and the user interface toolkit on the client is thereby generated. The remote-capable components may be created by a code-generating routine which reads in the component of the user interface toolkit, copies the code of the component, and substitutes a portion of the code relevant to performing the function of the component with a portion of code that issues a remote message to a component on a remote client to perform the same function.

### CROSS-REFERENCE TO RELATED APPLICATION

This application claims priority to U.S. Provisional Patent Application Serial No. 60/210,643, filed on Jun. 9, 2000, entitled “Method and System to Support Rich User Interfaces on Light Clients,” and U.S. Provisional Patent Application Serial No. 60/277,498, filed on Mar. 21, 2001, entitled “Thin Client Graphical User Interface Toolkit,” both of which are hereby incorporated by reference in their entirety herein.

### STATEMENT REGARDING FEDERALLY SPONSORED RESEARCH OR DEVELOPMENT

This application was supported in part by NSF Grant IIS-98-17434.

### REFERENCE TO COMPUTER PROGRAM LISTING

A computer program listing is appended hereto on a compact disc, and all material on said compact disc is hereby incorporated by reference in its entirety herein. More particularly, the compact disc contains at least the following files (including file size in bytes, date of creation of CD, and file name) as stored in the following directories:

These files are associated with the code generation doclet, which reads
in components of the baseline user interface toolkit (JFC) and generates
the code of remote-capable components of the remote-capable user
interface toolkit (RJFC), in which the remote-capable component is
created which differs from its baseline counterpart in that it issues a
remote message to perform the function.
Directory /codegen:

| | | |
|---|---|---|
| 538 | Jun 8 2001 | doclet_no_recurs.pl |
| 837 | Jun 8 2001 | doclet.pl |
| 568 | Jun 8 2001 | doclet_public_check.pl |
| 963 | Jun 8 2001 | event_doclet.pl |
| 4548 | Jun 8 2001 | factory_doclet.pl |
| 611 | Jun 8 2001 | make |
| 12475 | Jun 8 2001 | makefile |
| 1047 | Jun 8 2001 | makerjfc |
| 70 | Jun 8 2001 | rundoclet |

These files are associated with the RJFCFactory, which is code that
defines what elements the application can cause to be displayed on the
client.
Directory /rjfc:

| | | |
|---|---|---|
| 2048 | Jun 8 2001 | awt |
| 2048 | Jun 8 2001 | doc |
| 10240 | Jun 8 2001 | event |
| 263 | Jun 8 2001 | RClient.java |
| 1331 | Jun 8 2001 | RComponentFactory.java |
| 397 | Jun 8 2001 | RJFCApplication.java |
| 11429 | Jun 8 2001 | RJFCBorderFactoryImpl.java |
| 4913 | Jun 8 2001 | RJFCBorderFactory.java |
| 1101 | Jun 8 2001 | RJFCColorChooserFactoryImpl.java |
| 442 | Jun 8 2001 | RJFCColorChooserFactory.java |
| 205 | Jun 8 2001 | RJFCConstants.java |
| 79247 | Jun 8 2001 | RJFCFactoryImpl.java |
| 32602 | Jun 8 2001 | RJFCFactory.java |
| 330 | Jun 8 2001 | RJFCFileChooserFactoryImpl.java |
| 140 | Jun 8 2001 | RJFCFileChooserFactory.java |
| 96 | Jun 8 2001 | RJFCImdpFactory.java |
| 164 | Jun 8 2001 | RJFCPainter.java |
| 43323 | Jun 8 2001 | RJFCPlafFactoryImpl.java |
| 16617 | Jun 8 2001 | RJFCPlafFactory.java |
| 3229 | Jun 8 2001 | RJFCServer.java |
| 5302 | Jun 8 2001 | RJFCTableFactoryImpl.java |
| 2167 | Jun 8 2001 | RJFCTableFactory.java |
| 26885 | Jun 8 2001 | RJFCTextFactoryImpl.java |
| 11381 | Jun 8 2001 | RJFCTextFactory.java |
| 5959 | Jun 8 2001 | RJFCTreeFactoryImpl.java |
| 2588 | Jun 8 2001 | RJFCTreeFactory.java |
| 3185 | Jun 8 2001 | RJFCUndoFactoryImpl.java |
| 1250 | Jun 8 2001 | RJFCUndoFactory.java |
| 695 | Jun 8 2001 | Server.java |
| 16384 | Jun 8 2001 | swing |

The following files are remote-capable versions of the JFC components:
Directory /rjfc/awt:

| | | |
|---|---|---|
| 23806 | Jun 8 2001 | RComponentImpl.java |
| 12886 | Jun 8 2001 | RComponent.java |
| 9173 | Jun 8 2001 | RContainerImpl.java |
| 4244 | Jun 8 2001 | RContainer.java |
| 3482 | Jun 8 2001 | RDialogImpl.java |
| 1049 | Jun 8 2001 | RDialog.java |
| 3273 | Jun 8 2001 | RFrameImpl.java |
| 2473 | Jun 8 2001 | RFrame.java |
| 4766 | Jun 8 2001 | RWindowImpl.java |
| 2114 | Jun 8 2001 | RWindow.java |

Directory /rjfc/swing:

| | | |
|---|---|---|
| 2048 | Jun 8 2001 | border |
| 2048 | Jun 8 2001 | colorchooser |
| 4096 | Jun 8 2001 | event |
| 2048 | Jun 8 2001 | filechooser |
| 8192 | Jun 8 2001 | plaf |
| 2614 | Jun 8 2001 | RAbstractActionImpl.java |
| 1201 | Jun 8 2001 | RAbstractAction.java |
| 10078 | Jun 8 2001 | RAbstractButtonImpl.java |
| 7383 | Jun 8 2001 | RAbstractButton.java |
| 2303 | Jun 8 2001 | RAbstractCellEditorImpl.java |
| 1156 | Jun 8 2001 | RAbstractCellEditor.java |
| 1883 | Jun 8 2001 | RAbstractListModelImpl.java |
| 957 | Jun 8 2001 | RAbstractListModel.java |
| 2549 | Jun 8 2001 | RActionMapImpl.java |
| 1223 | Jun 8 2001 | RActionMap.java |
| 8891 | Jun 8 2001 | RBorderFactoryImpl.java |
| 3996 | Jun 8 2001 | RBorderFactory.java |
| 3593 | Jun 8 2001 | RBoxImpl.java |
| 1359 | Jun 8 2001 | RBox.java |
| 3556 | Jun 8 2001 | RBoxLayoutImpl.java |
| 1871 | Jun 8 2001 | RBoxLayout.java |
| 2309 | Jun 8 2001 | RButtonGroupImpl.java |
| 1155 | Jun 8 2001 | RButtonGroup.java |
| 2503 | Jun 8 2001 | RCellRendererPaneImpl.java |
| 1379 | Jun 8 2001 | RCellRendererPane.java |
| 1280 | Jun 8 2001 | RClientJPanel.java |
| 1973 | Jun 8 2001 | RComponentInputMapImpl.java |
| 906 | Jun 8 2001 | RComponentInputMap.java |
| 12179 | Jun 8 2001 | RDebugGraphicsImpl.java |
| 6613 | Jun 8 2001 | RDebugGraphics.java |
| 3794 | Jun 8 2001 | RDefaultBoundedRangeModelImpl.java |
| 1692 | Jun 8 2001 | RDefaultBoundedRangeModel.java |
| 5132 | Jun 8 2001 | RDefaultButtonModelImpl.java |
| 2809 | Jun 8 2001 | RDefaultButtonModel.java |
| 3996 | Jun 8 2001 | RDefaultCellEditorImpl.java |
| 1526 | Jun 8 2001 | RDefaultCellEditor.java |
| 2721 | Jun 8 2001 | RDefaultComboBoxModelImpl.java |
| 1197 | Jun 8 2001 | RDefaultComboBoxModel.java |
| 4651 | Jun 8 2001 | RDefaultDesktopManagerImpl.java |
| 2389 | Jun 8 2001 | RDefaultDesktopManager.java |
| 3824 | Jun 8 2001 | RDefaultFocusManagerImpl.java |
| 1693 | Jun 8 2001 | RDefaultFocusManager.java |
| 3903 | Jun 8 2001 | RDefaultListCellRendererImpl.java |
| 2026 | Jun 8 2001 | RDefaultListCellRenderer.java |
| 5282 | Jun 8 2001 | RDefaultListModelImpl.java |
| 2616 | Jun 8 2001 | RDefaultListModel.java |
| 5309 | Jun 8 2001 | RDefaultListSelectionModelImpl.java |
| 2509 | Jun 8 2001 | RDefaultListSelectionModel.java |
| 2594 | Jun 8 2001 | RDefaultSingleSelectionModelImpl.java |
| 1230 | Jun 8 2001 | RDefaultSingleSelectionModel.java |
| 2684 | Jun 8 2001 | RFocusManagerImpl.java |
| 1436 | Jun 8 2001 | RFocusManager.java |
| 3610 | Jun 8 2001 | RGrayFilterImpl.java |
| 1983 | Jun 8 2001 | RGrayFilter.java |
| 4344 | Jun 8 2001 | RImageIconImpl.java |
| 1435 | Jun 8 2001 | RImageIcon.java |
| 2749 | Jun 8 2001 | RInputMapImpl.java |
| 1318 | Jun 8 2001 | RInputMap.java |
| 1664 | Jun 8 2001 | RInputVerifierImpl.java |
| 815 | Jun 8 2001 | RInputVerifier.java |
| 7185 | Jun 8 2001 | RJAppletImpl.java |
| 3435 | Jun 8 2001 | RJApplet.java |
| 2331 | Jun 8 2001 | RJButtonImpl.java |
| 875 | Jun 8 2001 | RJButton.java |
| 2757 | Jun 8 2001 | RJCheckBoxImpl.java |
| 0 | Jun 8 2001 | RJCheckBoxImpl_Skel.java |
| 439326 | Jun 8 2001 | RJCheckBoxImpl_Stub.java |
| 887 | Jun 8 2001 | RJCheckBox.java |
| 2869 | Jun 8 2001 | RJCheckBoxMenuItemImpl.java |
| 836 | Jun 8 2001 | RJCheckBoxMenuItem.java |
| 5922 | Jun 8 2001 | RJColorChooserImpl.java |
| 2938 | Jun 8 2001 | RJColorChooser.java |
| 9057 | Jun 8 2001 | RJComboBoxImpl.java |
| 4552 | Jun 8 2001 | RJComboBox.java |
| 20564 | Jun 8 2001 | RJComponentImpl.java |
| 10821 | Jun 8 2001 | RJComponent.java |
| 3371 | Jun 8 2001 | RJDesktopPaneImpl.java |
| 1681 | Jun 8 2001 | RJDesktopPane.java |
| 6077 | Jun 8 2001 | RJDialogImpl.java |
| 1881 | Jun 8 2001 | RJDialog.java |
| 6612 | Jun 8 2001 | RJEditorPaneImpl.java |
| 3029 | Jun 8 2001 | RJEditorPane.java |
| 13215 | Jun 8 2001 | RJFileChooserImpl.java |
| 8607 | Jun 8 2001 | RJFileChooser.java |
| 4491 | Jun 8 2001 | RJFrameImpl.java |
| 1835 | Jun 8 2001 | RJFrame.java |
| 12373 | Jun 8 2001 | RJInternalFrameImpl.java |
| 6164 | Jun 8 2001 | RJInternalFrame.java |
| 5859 | Jun 8 2001 | RJLabelImpl.java |
| 2439 | Jun 8 2001 | RJLabel.java |
| 4344 | Jun 8 2001 | RJLayeredPaneImpl.java |
| 2738 | Jun 8 2001 | RJLayeredPane.java |
| 10260 | Jun 8 2001 | RJListImpl.java |
| 5074 | Jun 8 2001 | RJList.java |
| 6187 | Jun 8 2001 | RJMenuBarImpl.java |
| 2843 | Jun 8 2001 | RJMenuBar.java |
| 9045 | Jun 8 2001 | RJMenuImpl.java |
| 5566 | Jun 8 2001 | RJMenuItemImpl.java |
| 2450 | Jun 8 2001 | RJMenuItem.java |
| 3816 | Jun 8 2001 | RJMenu.java |
| 10360 | Jun 8 2001 | RJOptionPane.java |
| 3951 | Jun 8 2001 | RJTextPaneImpl.java |
| 2062 | Jun 8 2001 | RJTextPane.java |

Directory /rjfc/swing/border:

| | | |
|---|---|---|
| 2892 | Jun 8 2001 | RAbstractBorderImpl.java |
| 1483 | Jun 8 2001 | RAbstractBorder.java |
| 4139 | Jun 8 2001 | RBevelBorderImpl.java |
| 1842 | Jun 8 2001 | RBevelBorder.java |
| 2394 | Jun 8 2001 | RCompoundBorderImpl.java |
| 1097 | Jun 8 2001 | RCompoundBorder.java |
| 2175 | Jun 8 2001 | REmptyBorderImpl.java |
| 1001 | Jun 8 2001 | REmptyBorder.java |
| 3252 | Jun 8 2001 | REtchedBorderImpl.java |
| 1452 | Jun 8 2001 | REtchedBorder.java |
| 2944 | Jun 8 2001 | RLineBorderImpl.java |
| 1268 | Jun 8 2001 | RLineBorder.java |
| 3211 | Jun 8 2001 | RMatteBorderImpl.java |
| 1124 | Jun 8 2001 | RMatteBorder.java |
| 2223 | Jun 8 2001 | RSoftBevelBorderImpl.java |
| 804 | Jun 8 2001 | RSoftBevelBorder.java |
| 5170 | Jun 8 2001 | RTitledBorderImpl.java |
| 2687 | Jun 8 2001 | RTitledBorder.java |

Directory /rjfc/swing/colorchooser:

| | | |
|---|---|---|
| 2383 | Jun 8 2001 | RAbstractColorChooserPanelImpl.java |
| 1175 | Jun 8 2001 | RAbstractColorChooserPanel.java |
| 1893 | Jun 8 2001 | RColorChooserComponentFactoryImpl.java |
| 907 | Jun 8 2001 | RColorChooserComponentFactory.java |
| 2347 | Jun 8 2001 | RDefaultColorSelectionModelImpl.java |
| 1061 | Jun 8 2001 | RDefaultColorSelectionModel.java |

Directory /rjfc/swing/event:

| | | |
|---|---|---|
| 2950 | Jun 8 2001 | RAncestorEventImpl.java |
| 2648 | Jun 8 2001 | RAncestorEvent.java |
| 1574 | Jun 8 2001 | RCaretEventImpl.java |
| 750 | Jun 8 2001 | RCaretEvent.java |
| 1408 | Jun 8 2001 | RChangeEventImpl.java |
| 664 | Jun 8 2001 | RChangeEvent.java |
| 2255 | Jun 8 2001 | REventListenerListImpl.java |
| 1120 | Jun 8 2001 | REventListenerList.java |
| 2318 | Jun 8 2001 | RHyperlinkEventImpl.java |
| 889 | Jun 8 2001 | RHyperlinkEvent.java |
| 2979 | Jun 8 2001 | RInternalFrameAdapterImpl.java |
| 1519 | Jun 8 2001 | RInternalFrameAdapter.java |
| 2209 | Jun 8 2001 | RInternalFrameEventImpl.java |
| 3207 | Jun 8 2001 | RInternalFrameEvent.java |
| 1857 | Jun 8 2001 | RListDataEventImpl.java |
| 1037 | Jun 8 2001 | RListDataEvent.java |
| 2020 | Jun 8 2001 | RListSelectionEventImpl.java |
| 864 | Jun 8 2001 | RListSelectionEvent.java |
| 4924 | Jun 8 2001 | RMenuDragMouseEventImpl.java |
| 5013 | Jun 8 2001 | RMenuDragMouseEvent.java |
| 1380 | Jun 8 2001 | RMenuEventImpl.java |
| 654 | Jun 8 2001 | RMenuEvent.java |
| 5040 | Jun 8 2001 | RMenuKeyEventImpl.java |
| 15942 | Jun 8 2001 | RMenuKeyEvent.java |
| 2226 | Jun 8 2001 | RMouseInputAdapterImpl.java |
| 1212 | Jun 8 2001 | RMouseInputAdapter.java |
| 1450 | Jun 8 2001 | RPopupMenuEventImpl.java |
| 679 | Jun 8 2001 | RPopupMenuEvent.java |
| 3343 | Jun 8 2001 | RSwingPropertyChangeSupportImpl.java |
| 1741 | Jun 8 2001 | RSwingPropertyChangeSupport.java |
| 1864 | Jun 8 2001 | RTableColumnModelEventImpl.java |
| 814 | Jun 8 2001 | RTableColumnModelEvent.java |
| 2974 | Jun 8 2001 | RTableModelEventImpl.java |
| 1180 | Jun 8 2001 | RTableModelEvent.java |
| 1941 | Jun 8 2001 | RTreeExpansionEventImpl.java |
| 788 | Jun 8 2001 | RTreeExpansionEvent.java |
| 3186 | Jun 8 2001 | RTreeModelEventImpl.java |
| 954 | Jun 8 2001 | RTreeModelEvent.java |
| 4389 | Jun 8 2001 | RTreeSelectionEventImpl.java |
| 1396 | Jun 8 2001 | RTreeSelectionEvent.java |
| 1709 | Jun 8 2001 | RUndoableEditEventImpl.java |
| 766 | Jun 8 2001 | RUndoableEditEvent.java |

Directory /rjfc/swing/filechooser:

| | | |
|---|---|---|
| 1491 | Jun 8 2001 | RFileFilterImpl.java |
| 743 | Jun 8 2001 | RFileFilter.java |
| 3213 | Jun 8 2001 | RFileSystemViewImpl.java |
| 1513 | Jun 8 2001 | RFileSystemView.java |
| 2007 | Jun 8 2001 | RFileViewImpl.java |
| 1010 | Jun 8 2001 | RFileView.java |

The following are applications that use the remote-capable components:
Directory /servers:

| | | |
|---|---|---|
| 3296 | Jun 8 2001 | ButtonServer.java |
| 16032 | Jun 8 2001 | NotepadServer.java |
| 12183 | Jun 8 2001 | SheetServer.java |
| 6727 | Jun 8 2001 | WebBrowse.java |

These files include the viewer, which is the vehicle through which the
Remote-capable user interface toolkit application displays its output.
Directory /viewer:

| | | |
|---|---|---|
| 82 | Jun 8 2001 | policy |
| 7290 | Jun 8 2001 | Viewer.java |

### BACKGROUND OF THE INVENTION

This invention relates to computer systems using distributed user interfaces, and more particularly, to distributed user interfaces using user interface toolkits.

Many approaches have been researched academically and deployed commercially to support a distributed computing paradigm in which the network separates the presentation of the user interface from the application logic. Two approaches are commonly used in both industry and academia: web-based and remote frame-buffer-based. A third approach, distributed user interface toolkits, provides additional advantages, but still has significant drawbacks.

The first approach to distributed computing is one of the most widely deployed approaches to thin-client computing, and uses HyperText Transfer Protocol (HTTP) (See T. Berners-Lee et al., “Hypertext transfer protocol”—HTTP/1.0 RFC1945, 1996) and HyperText Markup Language (HTML) (See T. Berners-Lee et al., “Hypertext markup language”—2.0 RFC1866, 1995 and D. Conolly et al., “The text/html media type,” RFC2854, 2000) for the client with the server, commonly known as the world wide web. The architecture of an application developed using a web-based methodology is depicted in FIG. 1. As illustrated in FIG. 1, a server 10 is in communication with a client 12 over a network. The application logic 14 and the web server 16 reside on the server 10. A special web application programmer interface 18 (API) is provided to allow the application to communicate with the web server. Typical web API's are CGI (See “The Common Gateway Interface.” http://hoohoo.ncsa.uiuc.edu/cgi/overview.html), ISAP (See “ISAPI Extensions Overview.”

http://msdn.microsoft.com/library/psdk/iisref/isgu9kqf.htm), NSAPI (See NSAPI FAQ. http://developer.netscape.com/support/faqs/champions/nsapi.html), ASP (See “An ASP you can grasp: The ABCs of active server pages.”

http://msdn.microsoft.com/workship/server/asp/ASPover.asp.), PHP (See “PHP: Hypertext Preprocessor.” http://www.php.net), or JSP (See “JavaServer Pages: Dynamically Generated Web Content.” http://java.sun.com/products/jsp). HTTP is used to negotiate the transfer of HTML data between the client web browser 20 and the web server 16. The web browser 20 then renders the HTML 21 onto the client frame buffer 22, from which visual presentations are generated on the display of the client. The user may interact with the displayed presentation to send data back to the web server via HTML

One severe limitation of a web-based approach using HTTP/HTML is the “pull-only” data transfer methodology, which prevents the application from generating events. For example, when a user executes a search on a web search engine, the engine must ideally complete the search in its entirety within a few seconds of the request because the user is expecting an immediate response. After the initial page has been displayed, the web search engine cannot notify the user that better results have been found. A second problem is that HTTP is stateless, which makes it difficult for programmers to create even a simplistic notion of persistence between page accesses. In addition, the user interaction is also extremely limited, providing only a handful of the most commonly used interactive functions.

Many attempts have been made to address these problems, including sending entire applications over HTTP (e.g., JAVA™ applets. See JAVA™ Applets. http://java.sun.com/applets), designing browser “plug-ins” that interpret their own language to provide a richer user experience (e.g., Macromedia Flash and Shockwave See Macromedia, Inc. http://www.macromedia.com), creating a 3D world in which the user can navigate (e.g., VRML), and providing an application programmer interface (API) for storing persistent session identification data (e.g., cookies. See D. Kristol et al., “HTTP state management mechanism,” RFC2109, 1997). All these approaches to addressing the problems with HTTP/HTML create new problems.

JAVA™ applets raise numerous security concerns because HTTP is used to transport executable code to the client. Although the byte codes transmitted across the network are in compiled form, JAVA™ decompilers are readily available that will allow any user to have access to the source code of the application. In addition, the use of JAVA™ applets typically violates the thin-client principle of not running any application logic on the client. Flash and VRML define richer languages that have been built with user interactivity in mind, but suffer from the problem that mature browsers for anything other than the Microsoft Windows desktop operating systems are generally not available. HTTP cookies raise numerous security concerns because they permit the server program to write data to the permanent storage device on the client. In addition, HTTP cookies have been the target of severe criticism due to a recent surge in public awareness regarding privacy concerns when using the Internet. These issues make HTTP cookies an unattractive method for programmers to add server-side state to the HTTP protocol.

A second approach to distributed computing involves creating a remote virtual frame buffer on the server, on which the application can draw, and then transporting the resulting raster image to the client. In essence, this approach attempts to bring the server's desktop to the user and thereby permits a full range of user interactivity. Products such as CITRIX™ METAFRAME™ (See http://www.citrix.com/products/metaframe/), INSIGNIA SOLUTIONS™ NTRIGUE™ (See http://www.insignia.com), SCO TARANTELLA™ (See http://www.tarantella.sco.com), GRAPHON™ RapidX (See http://www.graphon.com) and SYMANTEC™ PCANYWHERE™ (See http://www.symantec.com) are among those that have been providing this type of functionality for many years as an extension to the underlying operating system. A recent explosion in the popularity of this approach occurred when AT&T released their cross-platform VNC system to the public free of charge. (See Q. Li et al., “Integrating Synchronous and Asynchronous Collaboration with VNC,” IEEE Internet Computing, 4(3):26-33, May-Jun 2000.) Microsoft has now made this capability a standard part of their Windows 2000 operating system (See http://www.microsoft.com/windQws2000/technologies/terminal/default.asp).

The architecture of a remote frame buffer based application is illustrated in FIG. 2 for transmission between a server 24 and client 26. The application 28 is typically written using a standard user interface toolkit API 30, such as JAVA™ Foundation Class (hereinafter “JFC”) (See “JAVA™ Foundation Classes: Now and the Future” http://java.sun.com/products/jfc/whitepaper.html), Microsoft Foundation Class (See Microsoft Visual C++ MFC Library Reference. Microsoft Press, Redmond, Wash., 1997), Tk (See J. Ousterhout. Tcl and the Toolkit. Addison-Wesley, 1994), or MOTIF (See Modular Toolkit Environment. IEEE 1295), and renders onto a remote virtual frame buffer 32. The resulting pixel data 34 is transported across the network using a proprietary protocol, such as ICA (See Citrix Metaframe.

http://www.citrix.com/products/metaframe), RFB (See “Microsoft Windows 2000 Terminal Services.”

http://www.microsoft.com/windows2000/guide/server/features/terminalsvs.asp), or RDP (See T. Ricardson et al., “Virtual network computing,” IEEE Internet Computing, 2(1):33-38, Jan-Feb 1998) to the client 26. The client viewer 36 receives the pixels and reconstructs the image, and then copies the image onto the client frame buffer 38 for presentation on the client's display.

Although the remote frame buffer approach addresses many of the problems with a web-based approach that uses HTTP/HTML, it also introduces a number of other problems. Whereas the web-based approach using HTTP/HTML is capable of operating reasonably well over relatively low-bandwidth modem network links, the remote frame buffer approach demands high-bandwidth connections. This is because the remote frame buffer approach is essentially sending a video stream of computer-generated graphics from the server to the client.

Although the use of advanced lossy video compression algorithms (e.g. MPEG (See ISO/IEC JTC1/SC2/WG11.MPEG. ISO, September 1990)) has been proposed (T. Ricardson et al., “Virtual network computing,” IEEE Internet Computing, 2(1):33-38, January-February 1998), implementation of such techniques may presents several technical difficulties. For example, real-time compression of MPEG streams usually requires special hardware that can only handle one or two streams at a time, thereby eliminating the possibility of using the remote frame buffer approach on a current shared server. In addition, the use of lossy compression techniques introduces unwanted compression artifacts into the display, reducing the system's usability, particularly when working with text and detailed graphics.

The existence of server-side state and asynchronous event generation by the server permits the remote frame buffer approach to provide a rich level of user interactivity that a web-based approach using HTTP/HTML cannot. However, there is a practical limitation caused by network latency. For example, such problems may arise in connection with the display of a mouse pointer on a typical client “viewer,” i.e., the remote frame buffer analogue of the web browser. Under certain circumstances, the client viewer may display two mouse pointers. One mouse pointer represents where the cursor should be pointing, and is tied to the local mouse. A second mouse pointer, which typically lags behind the first mouse pointer, displays where the mouse position is on the server. When a remote frame buffer system is run on anything other than a high-speed LAN connection (e.g., 100 megabit per second over category 5 cabling), there is always a noticeable difference in position between the client (virtual) and server (real) mouse positions. On a slow modem link (e.g., 56.6 kilobit per second transmission over a standard telephone line), this makes highly interactive user interfaces difficult to control, and, in extreme cases, may even make the system unusable.

A third approach to distributed computing is distributed user interface toolkits, which address the issues that arise when employing web-based HTTP/HTML and remote frame buffer approaches by allowing a server to manipulate user interface toolkit components directly on the client. The server can create, modify, and delete any of the components available in the distributed toolkit as if it were working with a local application. This approach is analogous to an implementation of a remote frame buffer with an extremely efficient, lossless compression algorithm. Instead of sending pixel data rendered on the server across the network, the distributed user interface toolkit sends the semantics necessary to render that pixel data on the client. In addition, since the mouse is handled locally on the client, there is no additional perceived latency beyond that caused by the processing that is necessary to service users requests when the application is running locally.

The current approaches to distributed user interface toolkits have several disadvantages. The X Window System (See R. Scheifler et al., “The X Window System,” ACM Trans. on Graphics, 5(2):79-109, April 1986), for example, transports low-level drawing commands. If a high-level user interface toolkit is used with X, the high-level user interface toolkit commands (e.g., draw button) are actually translated into low-level commands (e.g., lines and rectangles) before being transmitted across the network. Another disadvantage is that the X Window System stores state on the client computer that is presenting the output to the end user. Consequently, it is very difficult to “share” X Window System sessions between multiple users, and if the X Window System running on the client computer fails, the user session is lost. It is for these reasons that a remote virtual frame buffer system, such as VNC, is often employed to transport an X Window System desktop from a UNIX server to an X Window System viewer running on a UNIX workstation, rather than relying on the built-in networking facilities of X.

There is therefore a need in the art for a distributed user interface that runs the application logic on the server computer but which also allow the server computer to asynchronously generate events and transmit them to the server. There is also a need for a distributed user interface that allows relatively sophisticated graphics without requiring high-bandwidth connections. In addition, there is also a need for a distributed user interface which is easily implemented and does not require the creation of a new protocol of communication.

### SUMMARY OF THE INVENTION

It is an object of the invention to provide a distributed computer system which is compatible with toolkits of well-known programming languages and implicitly creates a protocol of network communication.

It is another object of the invention to provide a distributed computer system that does not require high-bandwidth to operate and which allows a high degree of user interactivity.

These and other objects of the invention which will become apparent with respect to the disclosure herein, are accomplished by a novel distributed computer system having at least one server and one remote client to execute an application entirely on the server, wherein the application so configured to interact with a user interface toolkit according to an application programming interface. A user interface toolkit is provided, which resides on the remote client and has at least one component configured to perform a function on the remote client. In an exemplary embodiment, JAVA™ Foundation Class is the user interface toolkit which has a plurality of components known as the Swing component class.

A remote-capable user interface toolkit resides on the server. The remote-capable user interface toolkit has at least one remote-capable component which interfaces with the application according to the same application programming interface as the user interface toolkit and which is configured to generate a message to perform the respective function of the corresponding component in the user interface toolkit in response to an invocation by the application. The remote-capable component is otherwise identical to the component.

The protocol of communication between the remote-capable component of the remote-capable user interface toolkit on the server and the component of the user interface toolkit on the client comprises the transmitting of messages by the remote-capable component invoked by the application.

The component in the user interface toolkit may be configured to render a graphical item and the remote-capable component may be configured to generate a command to render a graphical item. Similarly, the server may be configured to communicate the message to the user interface toolkit on the remote client to render a graphical item in response to the invocation by the application. The component of the user interface toolkit on the remote client may be configured to render the graphical item in response to the message.

The component in the user interface toolkit may be configured to install an event handler and the remote-capable component may be configured to generate a command to install an event handler. Similarly, the server may be configured to communicate the message to the user interface toolkit on the remote client to install an event handler, and the component of the user interface toolkit on the remote client may be configured to install the event handler in response to the message.

### BRIEF DESCRIPTION OF THE DRAWINGS

FIG. 1 is a simplified block diagram of a prior art system.

FIG. 2 is a simplified block diagram of a second prior art system.

FIG. 3 is a simplified block diagram of the system in accordance with the invention.

FIGS. 4(a)-4(c) illustrate prior art user interface toolkit components.

FIG. 5 illustrates a user interface in accordance with the invention.

FIGS. 6(a)-6(b) illustrate an application as rendered on a client buffer in accordance with the invention.

FIG. 7 illustrates another application as rendered on a client buffer in accordance with the invention.

FIG. 8 illustrates a further application as rendered on a client buffer in accordance with the invention.

FIG. 9(a) illustrates executable code in accordance with the invention.

FIG. 9(b) illustrates prior art executable code.

### DETAILED DESCRIPTION OF THE EXEMPLARY EMBODIMENTS

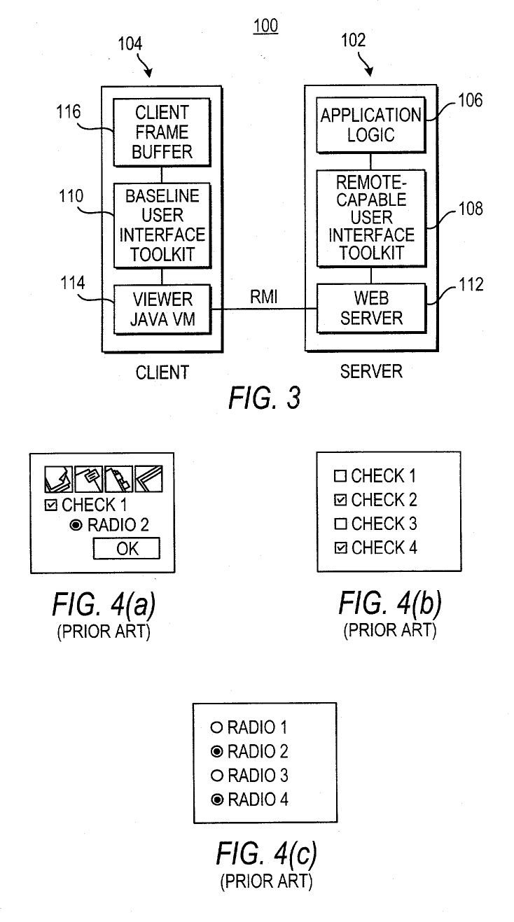

The architecture of a distributed user interface system 100 in accordance with the invention is illustrated in FIG. 3 and includes a server 102 and a client 104. The application logic 106 resides on the server 102. A novel remote-capable user interface toolkit 108 resides on the server 102 and a baseline user interface toolkit 110 resides on the client 104. As will be described below, the remote-capable user interface toolkit 108 has components which correspond to components in the baseline interface toolkit 110, but which issue remote messages rather than execute graphical functions. These messages are interpreted by a server JAVA™ virtual machine 112 (“server VM”) that transmits the commands across the network to the client 104. A client viewer JAVA™ virtual machine 114 (“client viewer”) translates the messages issued by the remote-capable user interface toolkit 108 into function calls of the baseline interface toolkit 110, which are rendered on the client frame buffer 116. It is noted that according to another exemplary embodiment, using a programming language other than JAVA™, the system is implemented without a virtual machine.

The distributed user interface system 100 makes use of visual components (often called widgets or controls) that are gathered together in libraries that are usually referred to as user interface toolkits. The exemplary embodiment utilizes JFC as the baseline graphical user interface toolkit 110. (The JAVA™ language specification, B Joy et al., The JAVA Language Specification, Addison Wesley, 2d Ed., 2000 and http://java.sun.com/docs/books/jls/second_edition/html/j.title.doc.html and JAVA™ virtual machine specification, T. Linde et al., The Java Virtual Machine Specification, Addison Wesley, 2d Ed., 1999 and http://java.sun.com/docs/books/vmspec/2ndedition/htmlUVMSpecTOC.doc.html, and “JAVA™ Foundation Classes: Now and the Future” http://java.sun.com/products/jfc/whitepaper.html, have been incorporated by reference in their entirety herein.) JFC has been utilized in the exemplary embodiment because of its ability to create cross-platform compatible graphical user interfaces. However, it is noted that the system and methods described herein are also compatible with any available toolkit.

A user interface toolkit, as understood in the specification and claims, is computer code which provides an application programming interface that (1) renders at least one graphical component related to user interaction in response to an invocation by the application, and (2) generates an event coupled to the graphical component in response to user interaction with that graphical component. These functions are described in greater detail herein. First, a toolkit has the ability to draw a frequently-used, graphical components on a user display as commanded by an application running on the computer. Each graphical component is concerned with an aspect of user interaction, and therefore visually provides the user with one or more selectable options as well as a manner of making a selection. Typical components in a toolkit draw graphical items such as buttons, scrollbars, menus, text fields, and the like. In rendering the graphical component, the toolkit may include commands to display a plurality of shapes, colors, and text. The toolkit is configured to interact with the application according to an application programming interface. For example, the toolkit receives an invocation, or call, from the application to draw graphical components at certain times during the operation of the application. In the exemplary embodiment, JFC has a well-defined application programming interface.

It is noted that a toolkit may comprise a single component, such as a button, or it may generate a plurality of multiple components. JFC, for example, provides many components bundled together in a component set referred to as “Swing.” (See “The Swing Component Galley”

http://java.sun.com/products/jfc/tsc/articles/component_gallery/index.html, which is incorporated by reference in its entirety herein.) Exemplary components of Swing include “JButton,” illustrated in FIG. 4(a), “JCheckbox,” illustrated in FIG. 4(b), and “JRadioButton,” illustrated in FIG. 4(c). JButton is a commonly used component that may be selected, i.e., “clicked,” by the user. JCheckbox is an image including a group of items and provides the user with the ability to select or de-select one or more of these items. Similarly, JRadioButton is an image including a group of buttons. In contrast with JCheckbox, JRadioButton allows only one button at a time to be selected. (According to convention, selecting a new button in JRadioButton will simultaneously select the new button and de-select a previously selected button.)

A second, related feature of a toolkit is the ability to generate an event based on a user response, if any, to the component rendered on the user display. The toolkit is thus able to provide a link between (1) the syntax of the user interaction (e.g., typing a character or pressing a mouse button), and (2) the semantics necessary to carry out the function commanded by that user interaction (e.g., closing a text window.) The toolkit includes an event handler that “listens” (i.e., waits), for a specific user interaction to occur, and then generates an event when that interaction occurs. (Each event may be represented by an object that gives information about the event and identifies the event source.). For example, a button (e.g., JButton), may be configured to wait for the user to click the button (i.e., press a mouse key while positioned over the button). When the user clicks the button, the toolkit generates an event. In this case, the result may be that a toolkit text window is automatically closed when the event listener detects an event triggered by the button component.

It is further noted that the procedures described herein are applicable to a user interface toolkit which “renders” an item to the user which may be graphical, audio, tactile, olfactory or other sensory modality, that may be coupled with the generation of an event in the nature of a user interface.

The toolkit, as described above, interacts with the application according to an application programming interface. In addition to receiving commands to draw graphical items, the toolkit generates events, which are usually associated with components. These events are then conveyed to the application according to the application programming interface, which enables the application to take some action based on the events generated by the user. JFC, as implemented in the exemplary embodiment, interacts with the application according to a well-defined application programming interface from the standpoint of conveying events to the application.

The user interface toolkit provides an abstraction layer for drawing the graphical items and generating events, by using the low-level drawing and interaction routines made available to programmers by the graphics subsystem that is usually bundled with the operating system. This abstraction allows programmers to quickly create commonly used visual components, such as buttons, scrollbars, menus, and text fields. End users also benefit, since most of the applications they run on a particular operating system will have roughly the same “look and feel” because the applications are all built out of components from the same user interface toolkit.

The typical implementation of a user interface toolkit, such as JFC, is on a system in which the application logic execution and the user interface presentation occur on a single computer. The tight binding of the user interface toolkit to the underlying graphics subsystem allows this type of implementation. However, the use of the toolkit when creating distributed applications in which the application logic execution and user interface presentation occur on different computers may present significant challenges.

With continued reference to FIG. 3, the distributed user interface system 100 is configured to work with any toolkit, as described above, which interfaces with application logic 106 and has the capability to draw graphical components and generate or respond to events. The system 100 includes a remote-capable interface toolkit 108, which resides on the server 102. As described above, JFC was used as the baseline user interface toolkit 100 implemented on the client 104, and “Remote JAVA™ Foundation Classes” (RJFC) was created as a remote-capable version of JFC. JFC was selected as a baseline interface toolkit 108 for the exemplary embodiment because of its familiarity to programmers and richness in functionality. JFC API is extremely complex, and includes over 600 individual source files, each providing between 10 to 100 methods for the programmer to use.

The remote-capable version of the toolkit 108 is a toolkit which appears to the application logic 106 as a local toolkit for drawing graphical components and generating events. However, when invoked by the application logic 106, the remote-capable user interface toolkit issues a remote process invocation, such as JAVA™ RMI, for drawing the graphics or generating events on the remote client 104. More particularly, RJFC has one or more components that are substantially identical to components in the corresponding baseline toolkit 110, JFC. Thus, there is a one-to-one correspondence between JFC components and RJFC components. A significant difference between these components, however, is that a JFC component, when invoked, locally performs a particular function (e.g., it draws a button on the local VM or it generates an event, as described above). In contrast, the corresponding RJFC component is configured to send a message to perform that same function, i.e., drawing a graphical item or generate an event, which is transmitted to the remote client 104. Alternatively, if the RJFC component is an event handler, it is configured to receive a remote signal concerning the occurrence of an event. Thus, the application programming interface of the RJFC 108 tracks the design pattern and functionality of the application programming interface of the standard JFC 110 as closely as possible, with the exception that the presentation displays on a remote client 104 or the event is generated at the remote client 104, rather than on a local frame buffer.

RJFC components are generated automatically from the JFC source code by a “code generator” application. Since the source code to JFC is readily available, a code generator reads the JFC source and produces a RJFC component for each JFC component. In the exemplary embodiment, a modified version of JAVA™ Doclet has been used to read the JFC source code in the JAVA™ programming language and to produce RJFC code (also in the JAVA™ programming language) for each respective JFC component. The Doclet is a publicly available tool that was designed to read in source code and automatically generate documentation. In accordance with the invention, the Doclet has been modified to generate source code in the JAVA™ programming language rather than documentation.

The procedure of using a code generator provides a great degree of automation and flexibility because the components of the remote-capable toolkit 108 do not have to be separately and individually programmed. In addition, the remote-capable toolkit components do not have to be rewritten if the underlying toolkit is modified. This approach may be used to generate different versions of the remote-capable toolkit system for various implementations and releases of the JAVA™ SDK, making it possible to handle a broad range of supported JAVA™ VM's.

Another advantage of creating the remote-capable toolkit by use of a code generator is that the application programming interface of the remote-capable user interface toolkit 108 is implicitly identical to the application programming interface of the baseline interface toolkit 110 which resides on the client 104. Consequently, manipulation of the RJFC components (e.g., changing the text of a label) and association of event handlers by the application logic 106 is syntactically identical to the JFC API. Although each RJFC component has an actual associated JFC component that resides in the client viewer's memory space, the application logic 106 which resides on the server 102 interacts with the remote client 104 by making calls on the RJFC components on the server 102 alone. Since the actual JFC components that are used to create the display on the client frame buffer are hidden from the application logic 106, the application logic 106 is not modified to operate in the distributed environment. Since RJFC components track the JFC API and follow the Sun JAVA™ Beans standard (See G. Voss “JAVA™ Beans” http://developer.java.sun.com/developer/onlineTraining/Beans/Beansl/simpledefinition.html), they may also be easily used in graphical user interface builders such as SUN FORTE™ for JAVA™ (See http://www.sun.com/forte/ffj), BORLAND™ JBUILDER™ (See http://www.borland.com/jbuilder) and WEBGAIN™ VISUALCAFE™ (See http://www.webgain.com/products/visual_cafe).

The procedure for distributed processing through a server and a remote client proceeds as follows. The application logic 106 is executed entirely in the server 102. The application logic 106 is configured by the programmer to interact with the user interface toolkit according to an application programming interface. A user interface toolkit, as defined above, comprises one or more components that perform several functions: the component may render a graphical item when invoked by an application, and may generate an event in response to a user interaction with that graphical item. In the exemplary embodiment, the baseline user interface toolkit 110 may be JFC, and the components may be the Swing component set.

An early stage in the procedure may be to provide the user interface toolkit 110 on the remote client 104 such that the component is configured to perform the function on the remote client 104. In the exemplary embodiment, the JFC components are provided on the remote client and are able to render the graphical items on the client frame buffer 116 and generate events at the remote client VM 114.

A subsequent stage may be to provide a remote-capable user interface toolkit 108 on the server 102. The remote-capable user interface toolkit 108 is provided by creating at least one remote-capable component which is configured to interact with the application logic 106 according to the same application programming interface as the baseline user interface toolkit 110 and which is configured to generate a remote message to the component on the remote client 104 to perform the respective function on the remote client 104. According the exemplary embodiment, the remote-capable user interface toolkit 108 is referred to as RJFC wherein each component of RJFC is syntactically identical to each component in JFC, with the except that the portion of the code in the remote-capable component has been substituted with a portion of code that generates a remote message to the JFC component to perform the same function.

A next stage in the procedure may be to invoke the remote-capable user interface toolkit 108 by the application logic 106 according to the application programming interface to perform a function. At a subsequent stage, the remote-capable user interface toolkit 108 generates a remote message to perform the function invoked by the application logic 106. Since there is a one-to-one correspondence between the JFC component and the RJFC component, a protocol of communication between the RJFC component and the JFC component is implicitly defined. This protocol of communication comprises the transferring of massages to perform JFC functions, and such messages are issued in the manner in which the JFC toolkit would normally perform functions on a single computer. Therefore, there is no need to specifically create a protocol of communication.

The message may be communicated between the remote-capable user interface toolkit on the server and the user interface toolkit on the remote client in a subsequent step. In the exemplary embodiment, this communication between the server 102 and the client 104 uses remote method invocation (RMI) (See S. McPherson, “JAVA™ Servlets and Serialization with RMI,” http://developerjava.sun.com/developer/technicalArticles/RMI/rmi/.

A later stage may be to perform the function on the remote client by the component of the user interface toolkit in response to the message. Thus, when an RJFC component is instantiated, modified, or deleted on the server 102 by the application logic 106, the RJFC toolkit 108 transparently informs the client viewer 114 of the event that has occurred. The client viewer 114 reacts to the message by performing the exact same action on the client viewer 114 that would have occurred on the server 102 if the JFC API were used.

For example, the standard JFC component JButton serves as the basis for the RJFC component RJButton. (Whereas JButton renders a button, RJButton sends a message to remotely render a button.) If the server 102 requests that a new RJButton be created, the RJFC toolkit 108 would generate a message which the server VM 112 transmits to the client viewer 114. The client viewer 114 receives the message and then creates a JButton using the standard JFC API 110, thus causing the actual button to be rendered on the client frame buffer 116. Similarly, when the server 102 installs an event handler into a RJFC component, the server 102 communicates with the client viewer 114, using RMI, to install a proxy JFC event handler into the associated JFC component that is being displayed on the client frame buffer 116.

One key performance optimization in the RJFC Protocol is the use of a component-generating object, referred to in the exemplary embodiment as “RJFCFactory,” that resides in the client viewer's memory space. RJFCFactory is a piece of code that defines what components the application logic 106 can cause to appear on the client 104. This code for RJFCFactory is automatically generated by the code generator, described above. The code generator reads the JFC source code and creating a remote-capable method for each baseline JFC method. RJFCFactory performs two actions: (1) it creates JFC components in the client viewer's memory space and (2) transmits to the server 102 a reference to RJFCFactory. (In the exemplary embodiment implemented in the JAVA™ programming language, RJFCFactory extends UnicastRemoteObject and implements an interface that extends Remote.) When a client viewer 114 connects to a server 102, the client viewer 114 passes the reference to the RJFCFactory during a display registration method implemented on the server 102. Once the server 102 has received the reference to RJFCFactory, the server 102 can do the following: (1) transmit commands to RJFCFactory to create JFC components that reside in the client viewer's memory space and (2) receive a remote reference to the associated RJFC wrapper object from the client 104. This procedure eliminates the need to create a serialized object in the server's memory space, subsequently send the serialized object to the client 104, and then send a remote reference to the wrapper object back to the server 102. Test measurements show that a RMI call as described above consumes approximately five Ethernet packets whereas sending a serialized JButton consumes more than ten times that number.

The protocol for the remote-capable user interface toolkit 108 in accordance with the invention accomplishes event handling using a similar methodology. The following protocol may be followed to allow the client 104 to transmit client-generated events to the server 102: If an event handler is installed into a RJFC component on the server 102, the server 102 may transmit a simple message to the client viewer 114, using RMI, that tells the client viewer 114 to install a proxy event handler in the associated JFC component. The proxy event handler on the client 104 makes a call to the server 102 whenever a new event is generated on the client side. The actual semantics of the event handler, as defined by the application logic 106, is executed on the server 102 when the server 102 receives the RMI call from the client 104. Similarly, the following protocol may be followed for transmitting server-generated events to the client 104: The server 102 retains the reference to the RJFC component returned by the RJFCFactory after the display initialization is completed. When the server 102 generates events, it transmits a command to the client 104 with a remote reference to the RJFC component. This protocol enables the server 102 to asynchronously generate events at will, i.e., without requests from the user at the remote client.

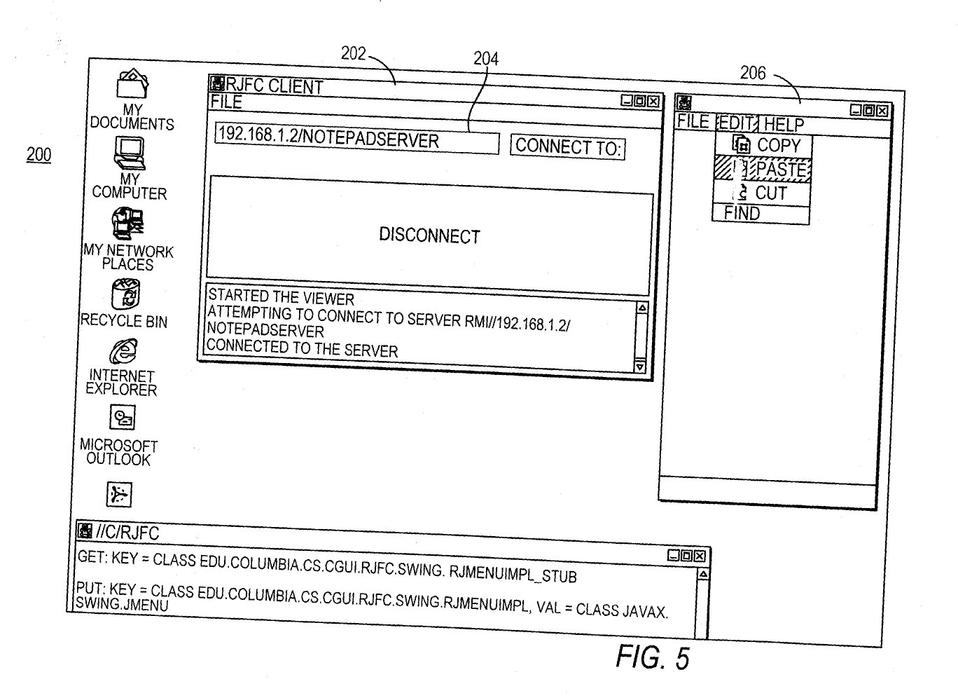

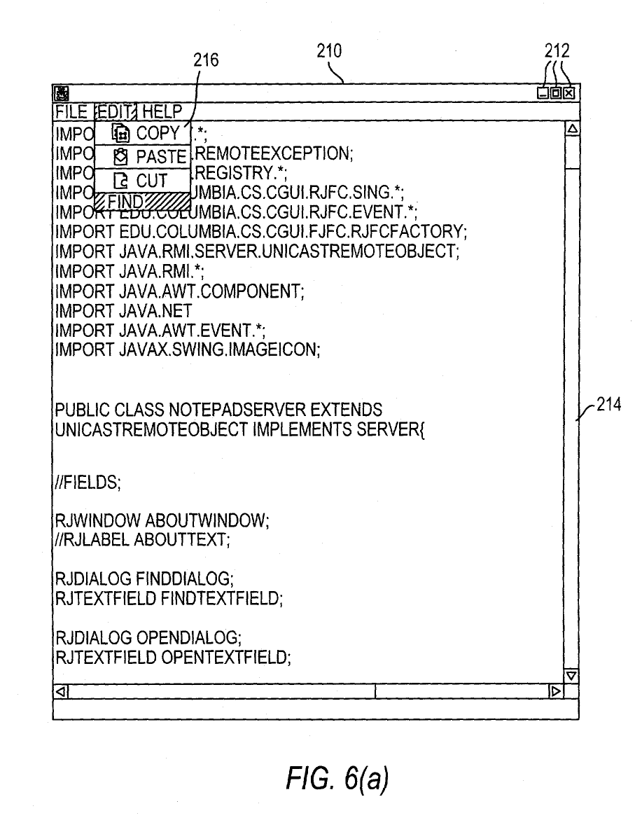

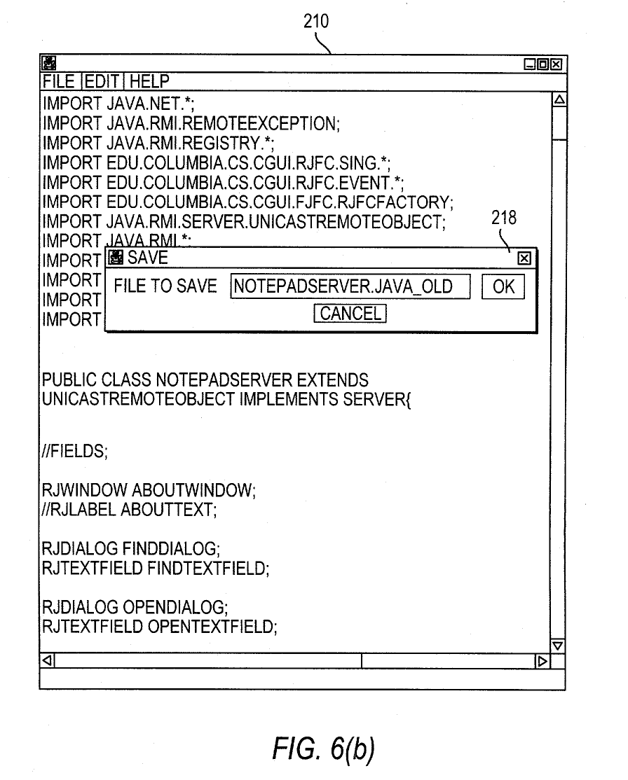

An exemplary RJFC viewer 200, as illustrated in FIG. 5, provides a context in which the application logic 106 which resides on the server 102 can manipulate the client frame buffer 116. The viewer is an application, which may be hand-coded, that uses the baseline interface toolkit 110, e.g., JFC, and emulates the functionality found in a typical thin-client system. The user of the system invokes the client viewer 114, at which point a JFrame window 202 is created with a form 204 that allows the user to connect to a server 102. Once a connection is established, a second JFrame window 206 is created for the server 102 to manipulate remotely. The server 102 may also request that additional windows be created by asking for dialogue boxes using the RJFC API. FIGS. 6-8 illustrate several small applications being run in the client viewer 114. FIGS. 6(a)-6(b) illustrate a “notepad” application 210 being run on the client viewer 114 as rendered by the JFC toolkit 110 in response to commands from the RJFC toolkit 108 residing on the server 102 as described herein. The notepad application 210 implements several of the JFC Swing components, such as JButton 212, JScrollPane 214, JPopUpMenu 216, and JOptionPane 218.

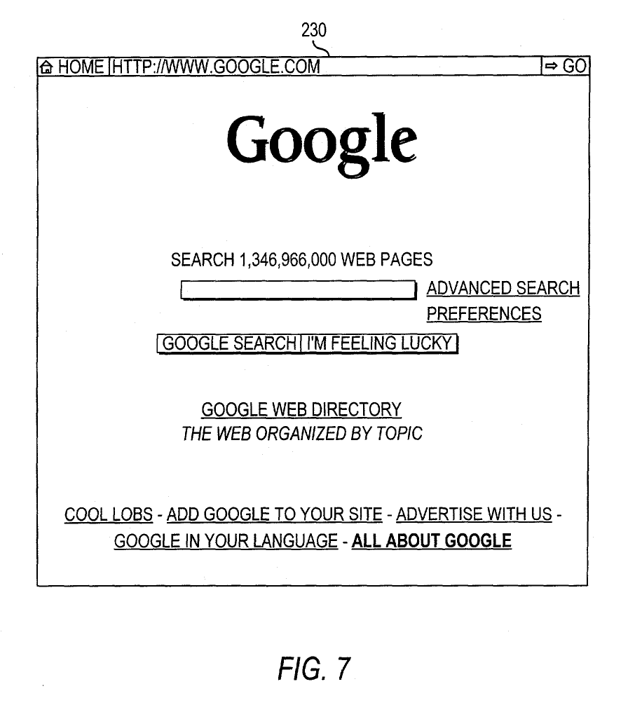

Similarly, FIG. 7 illustrates a simple web browser application 230 which conducts searches for web pages in response to user requests, as is well known in the art. As described above, the invention provides the capability to transmit server-generated events to the client 104: In the exemplary embodiment, RJFCFactory object resides on the client 104, and it sends an RJFCFactory reference to the server 102 during the display initialization. The server 102 retains this reference to the RJFC component. When the server 102 generates events, it transmits a command to the client 104 with a remote reference to the RJFC component. This protocol enables the server 102 to asynchronously generate events at will, i.e., without requests from the user at the remote client. As illustrated in FIG. 7, the application may be a web browser. The protocol according to the invention provides a substantial benefit over the HTTP/HTML web browser applications. For example, when the user requests a web search, the server sends commands to the client to display initial results of the search. (This is similar to the HTTP/HTML system.) However, in accordance with the invention, the server 102 may continue to search for additional results. When these newer results are found, the server 102 generates an event, and is able to transmit an RJFC command to the client with a RJFCFactory reference to the appropriate JFC component on the client 104 to display the results on the client frame buffer 114. This process may proceed asynchronously to update the search results without any further inputs from the user.

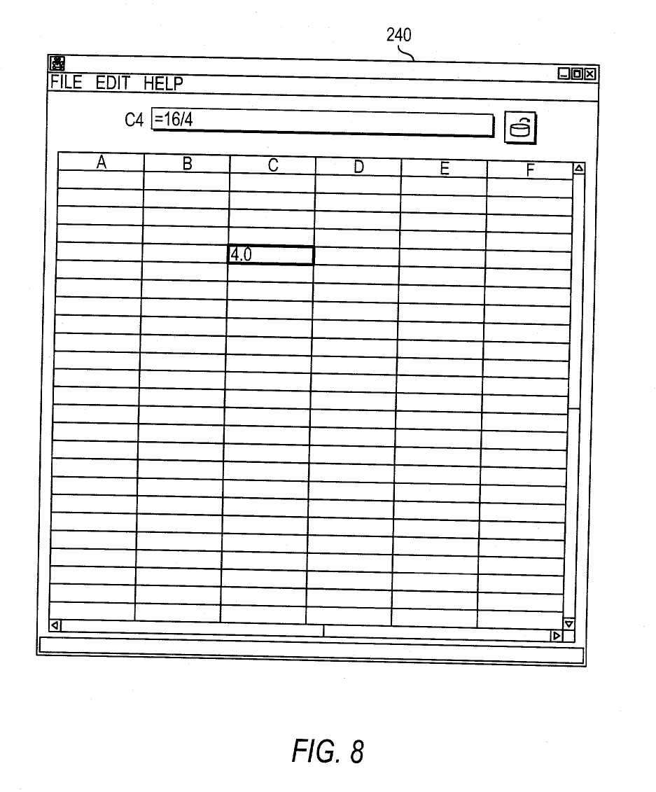

FIG. 8 illustrates a simple spreadsheet application 240, each of which is rendered on the client buffer 116 in response to commands generated by the RJFC toolkit 118 in accordance with the invention.

### EXAMPLE

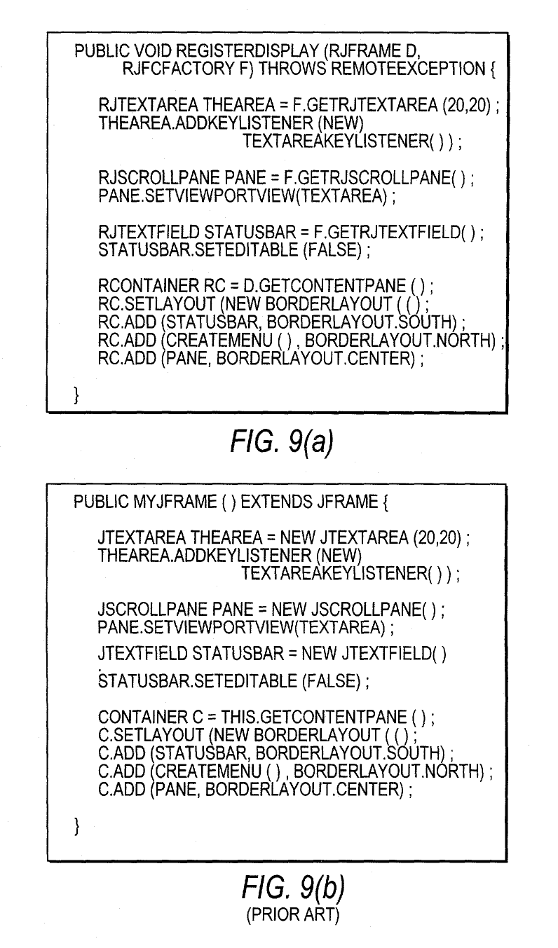

An example of code for creating a simple “notepad” application written using the RJFC API is shown in FIG. 9(a), and a baseline, i.e., non-network-aware version of the code in JFC API is shown in FIG. 9(b). The code generator was configured such that the resulting RJFC API has a one-to-one correspondence to JFC components. In the exemplary embodiment, a capital “R” (indicative of the remote-capable functionality) is prepended to the name of the toolkit component being referenced. The significant difference between the non-network-aware JFC application of FIG. 9(b) and the remote-capable RJFC application of FIG. 9(a) is that the JFC code calls “new” to instantiate a component, whereas the RJFC code makes a remote method invocation to an RJFCFactory object (as described above) which resides in the client viewer's memory space.

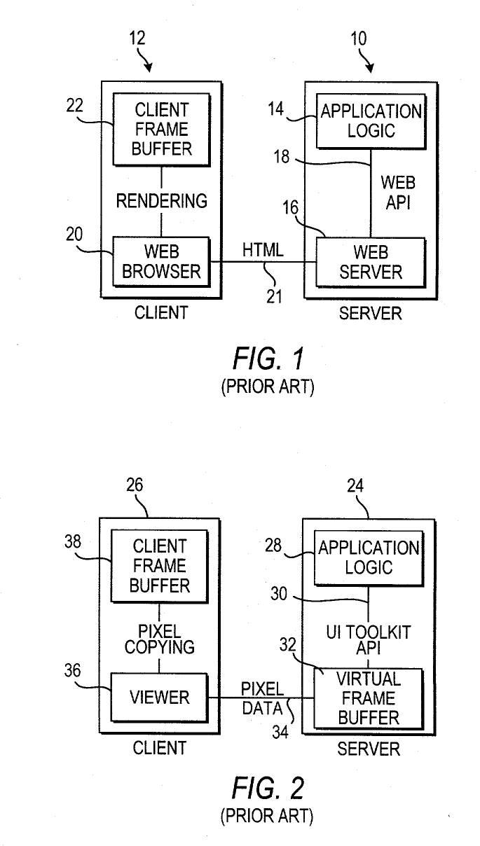

The distributed user interface in accordance with the invention was compared with the web-based thin-client approach using HTTP/HTML as illustrated in FIG. 1 and the remote frame buffer approach as illustrated in FIG. 2, above. The implementation of HTTP/HTML consumes very little bandwidth because HTML represents a presentation's semantics at an extremely high level. While this causes a relatively small amount of information to be transported, this approach suffers from the problem that HTTP was not designed for implementing remote applications, but rather for sharing static data.

In contrast, the remote frame buffer approach operates on the premise that compatibility with existing applications is paramount at the expense of network bandwidth. This is because many of the remote frame buffer implementations were designed for corporate or lab network environments whose administrators are trying to move users away from desktop computers to a thin-client subsystem with a lower total cost of ownership.

The RJFC distributed user interface toolkit in accordance with the invention combines the benefits of both approaches without their performance and usability issues by transmitting the high-level semantics of a display using a standard toolkit API. The network bandwidth consumed by RJFC is closer to that of the web-based approach using HTTP/HTML than that of the remote frame buffer approach, while permitting rich user interaction without artificially introduced latency. TABLE 1 is a comparison of the bandwidth consumed by RemoteJFC and the AT&T VNC remote frame buffer system. TABLE 1 shows the number of Ethernet packets transmitted over the network by VNC and by the distributed user interface system 100 using the remote-capable user interface toolkit 108 when simple operations were performed in a notepad application similar to that illustrated in FIG. 9(a). In the VNC system, a large number of packets transmitted were due to movement of the mouse by the user. The amount of mouse movement by a novice user may be significantly greater than the movement of a more experienced user. Since the amount of user experience may affect the comparison, both VNC novice and VNC expert data is included in TABLE 1. (Since a web-based method using HTTP/HTML would not be able to provide the same level of user interactivity, this approach was omitted from TABLE 1. It is noted, however, that the Client Connection cost of a web-based “notepad” application is approximately 10 packets.)

TABLE 1

| Operation | RJFC | VNC Expert | VNC Novice |
|---|---|---|---|
| Client Connection | 620 | 450 | 450 |
| Load File | 85 | 860 | 2600 |
| Popup About Dialog | 24 | 70 | 1500 |
| Close About Dialog | 32 | 85 | 630 |
| Maximize Window | 8 | 690 | 1000 |
| Scroll to Bottom of Page | 0 | 420 | 1700 |

Thin-client systems need some kind of software browser or viewer that must reside in permanent storage on the client computer. Because the web-based approach and the novel remote-capable user interface toolkit approach both transmit high-level information across the network, the size of the client software package is therefore larger than that of the VNC viewer.

The size of a typical web browser download is about 25 megabytes, as compared to the VNC viewer which can be about 110 kilobytes. The client viewer 114 lies somewhere in between: the RJFC library adds 2.5 megabytes to the underlying JAVA™ runtime environment, which can vary in size from 30 to 15 megabytes. In addition, the VNC viewer memory image when attached to an 800×600 desktop consumes 1.5 megabytes of RAM, whereas both the web browser and client viewer 114 require approximately ten times that amount. This also results in faster startup times for the VNC viewer than a web browser or the client viewer 114.

Overall, the remote frame buffer approach is much “thinner” than the web-based and RemoteJFC approaches and is capable of running on less powerful hardware, but requires much more network bandwidth to operate effectively.

It will be understood that the foregoing is only illustrative of the principles of the invention, and that various modifications can be made by those skilled in the art without departing from the scope and spirit of the invention.

We claim:

1. A method for distributed processing through a server and a remote client wherein an application is executed entirely in the server, wherein the application is configured to interact with a user interface toolkit according to an application programming interface, and wherein the user interface toolkit has a component that performs a function, the method comprising:
providing the user interface toolkit on the remote client such that the component is configured to perform the function on the remote client;
providing a remote-capable user interface toolkit on the server by creating a remote-capable component which is configured to interact with the application according to the application programming interface and which is configured to generate a message to the component on the remote client to perform the respective function on the remote client;
invoking the remote-capable user interface toolkit by the application to perform a function according to the application programming interface;
generating the message to perform the function by the remote-capable component of the remote-capable user interface toolkit on the server in response to the invocation by the application;
communicating the message between the remote-capable user interface toolkit on the server and the user interface toolkit on the remote client; and
performing the function on the remote client by the component of the user interface toolkit in response to the message.

2. The method of claim 1, wherein the component in the user interface toolkit is configured to render a graphical item and the remote-capable component is configured to generate a message to render the graphical item, and wherein communicating the message between the remote-capable user interface toolkit on the server and the user interface toolkit on the remote client comprises transmitting the message to the user interface toolkit on the remote client to render the graphical item.

3. The method of claim 2, wherein performing the function on the remote client by the component of the user interface toolkit comprises rendering the graphical item on the remote client in response to the message.

4. The method of claim 1, wherein the component in the user interface toolkit is configured to install an event handler and the remote-capable component is configured to generate a message to install the event handler, and wherein communicating the message between the remote-capable user interface toolkit on the server and the user interface toolkit on the remote client comprises transmitting the message to the user interface toolkit on the remote client to install an event handler.

5. The method of claim 4, wherein performing the function on the remote client by the component of the user interface toolkit comprises installing the event handler on the remote client in response to the message.

6. The method of claim 1, which further comprises:
generating an event by the remote-capable component of the remote-capable user interface toolkit in response to the step of invoking; and
wherein communicating the message between the remote-capable user interface toolkit on the server and the user interface toolkit on the remote client comprises asynchronously transmitting the event to the user interface toolkit.

7. The method of claim 6, wherein the application is a database searching application configured to search a database for information in response to a user-defined request,
wherein the step of generating an event by the remote-capable component of the remote-capable user interface toolkit comprises identifying information from the database in response to the user-defined request; and
wherein the step of asynchronously transmitting the event to the user interface toolkit comprises asynchronously transmitting a message to the remote client to render the information from the database identified in the step of generating an event.

8. The method of claim 7, wherein the application is a web browser and wherein the database is the World Wide Web,
wherein the step of identifying information from the database comprises identifying information from the World Wide Web; and
wherein the step of asynchronously transmitting a command to the remote client to render the information from the database comprises asynchronously transmitting a command to the remote client to render the information from the World Wide Web.

9. The method of claim 1 wherein the step of providing a remote-capable user interface toolkit on the server further comprises:
providing a code-generating computer program configured to read in the code of the component of the user interface toolkit and to generate the remote-capable component of the remote-capable user interface toolkit by substituting a portion of the code relevant to executing the function with a portion of code configured to issue a remote command to execute the function;
reading in the code of the component of the user interface toolkit;
generating the remote-capable component of the remote-capable user interface toolkit by copying the code of the component and by substituting the portion of the code relevant to executing the function with the portion of code configured to issue the remote command to execute the function

10. A distributed computer system having at least one server and one remote client wherein the server executes the entire application on the server, wherein the application is configured to interact with a user interface toolkit according to an application programming interface, and wherein the user interface toolkit has a component that performs a function, the distributed computer system comprising:
a user interface toolkit on the remote client having a component configured to perform a function on the remote client;
a remote-capable user interface toolkit on the server having a remote-capable component which is configured to interact with the application according to the application programming interface, and which is configured to generate a message to the component on the remote client to perform the respective function on the remote client in response to an invocation of the function by the application;
a server configured to communicate the message between the remote-capable user interface toolkit on the server and the user interface toolkit on the remote client; and
a remote client configured to performing the function by the component of the user interface toolkit in response to the message.

11. The distributed computer system of claim 10, wherein the component in the user interface toolkit is configured to render a graphical item and the remote-capable component is configured to generate a message to render the graphical item

12. The distributed computer system of claim 11, wherein the server is configured to communicate the message to the user interface toolkit on the remote client to render the graphical item.

13. The distributed computer system of claim 12, wherein the component of the user interface toolkit on the remote client is configured to render the graphical item in response to the message.

14. The distributed computer system of claim 10, wherein the component in the user interface toolkit is configured to render an item and the remote-capable component is configured to generate a message to render the item

15. The distributed computer system of claim 14, wherein the server is configured to communicate the message to the user interface toolkit on the remote client to render the item.

16. The distributed computer system of claim 15, wherein the component of the user interface toolkit on the remote client is configured to render the item in response to the message.

17. The distributed computer system of claim 10, wherein the component in the user interface toolkit is configured to install an event handler and the remote-capable component is configured to generate a command to install an event handler.

18. The distributed computer system of claim 17, wherein the server is configured to communicate the message to the user interface toolkit on the remote client to install the event handler.

19. The distributed computer system of claim 18, wherein the component of the user interface toolkit is configured to install the event handler on the remote client in response to the message.

20. The distributed computer system of claim 10:
wherein the remote-capable component of the remote-capable user interface toolkit is configured to generate an event in response to the step of invoking; and
wherein the server is configured to asynchronously communicate a message to generate the event to the user interface toolkit on the remote client.
